(19) United States
(12) Patent Application Publication
(10) Pub. No.: US 2002/0083606 A1
(43) Pub. Date: Jul. 4, 2002

(54) Offset level

(76) Inventors: Joseph E. Monteil, Cleveland, MO (US); Floyd Waller, Peculiar, MO (US)

Correspondence Address: Attn: Peter C. Knops, Lathrop & Gage, L.C., Suite 2800, 2345 Grand Boulevard, Kansas City, MO, 64108, US

(21) Appl. No.: 09/751,218

(22) Filed: Dec. 28, 2000

(51) Int. Cl. E01C 23/01; G01B 5/02

(52) U.S. Cl. 33/521; 33/1 H; 33/295; 33/832; 33/624

(57) ABSTRACT

The present invention is directed to an offset level for translating a particular grade location and line location from a reference point. The offset level includes a ruler for measuring vertical height from the reference point and a housing selectively slibable on the ruler for positioning the housing at the specific vertical height from the reference point. The offset level further includes a pointer extending outwardly from the housing for translating the desired vertical measurement to an offset location. The pointer also includes a ruler component to permit a horizontal distance to be measured from the reference point to establish a line. The offset level further includes a leveling device to insure the horizontal alignment of the pointer during the line and grade designations.

### BACKGROUND OF THE INVENTION

1. Field of the Invention

This invention relates generally to equipment for designating the line and grade for paving machines and more particularly the invention is directed to an apparatus for translating a specific vertical height component and a particular horizontal distance from a reference point to a position offset from the reference point for facilitating the placement of guide wires in constructing a road surface.

2. Background of the Invention

Asphalt concrete is typically laid down by a paving machine which receives a bulk amount of heated asphalt concrete mixture (commonly known as hot mix asphalt) and then meters the mixture into an eight to twelve feet wide (or wider) onto the road base as the machine moves forwardly. Multiple lanes are laid side by side until the asphalt concrete mat has covered the entire width of the roadway or other surface to be covered. Each lane is compacted by a very heavy roller machine which includes a large cylindrical drum or a plurality of closely spaced pneumatic tires, or a combination of both. The compacting machine is driven repeatedly over each lane of the asphalt concrete after it is laid to compact or consolidate the material.

In order to properly lay the concrete, the paving machine requires a specified path (line) of travel and a reference to grade. These references are normally provided by one or more guide wires that the paving machine senses and follows. In many applications, guide wires are placed on both sides of the machine. The placement and maintenance of the guide wires is labor intensive and expensive.

These guide wires are accurately surveyed into place along the specified path of travel at an elevation that can be used as a reference to grade Typically, this information is provided on hubs that are seperated by a certain distance (e.g., 20 feet). The hubs denote the line and path from the hub. The guide wires must then be placed at this designated location offset from the hub both vertically and horizontally. This is done by measuring the designated distance from the surveying block, placing a stake at this location and then noting the grade on the stake by measuring the height provided by the surveyor. As this is done for the path of the proposed roads, a line of stakes with flags are laid out that designate the proper line and grade location for the guide wire. A guide wire is then positioned along the noted line and grade to properly install the guide wire.

As discussed, this process involves two steps: first, marking the distance from the surveying blocks to determine the line; and second, accurately marking the grade from the subterrain. What is needed is a device by which the grade and line is determinable from a reference point in one step. Preferably, such a device would be lightweight and mobile to allow for the line and grade designation of many points along a surface to be accomplished quickly and easily. Additionally, adjusting the vertical height and angle for designating a grade, as well as positioning the offsetting means to reach the guide wire, should be a simple and efficient operation.

### SUMMARY OF THE INVENTION

The principal objects and advantages of the present invention include: providing a measurement apparatus for accurate designation of a specific grade and line of a surface to a location offset from a reference point; providing such a device that can be used by a single individual to accomplish the line and grade designation quickly and easily; providing such a device that is simple and efficient in operation, requiring only mechanical movements and no electronics or a power source to operate; providing such a device that is lightweight for ease of transport and use; and providing such a device that generally does not require specialized skills to operate correctly.

The present invention attains these objects and provides an offset level for translating a predetermined line and grade from a reference point. The offset level includes a ruler for measuring vertical height from the reference point and a housing selectively slibable on the ruler for positioning the housing at a specific location on the ruler. The offset level further includes a pointer extending outwardly from the housing for translating the desired vertical measurement to an offset location. The pointer also includes a ruler component to permit the line to be measured from the reference point. The housing also has a leveling device to insure that for horizontal alignment of the pointer during the offset location designation.

Other advantages and components of the present invention will become apparent from the following description taken in conjunction with the accompanying drawings, which constitute a part of this specification and wherein are set forth exemplary embodiments of the present invention to illustrate various objects and features thereof.

### BRIEF DESCRIPTION OF THE DRAWINGS

FIG. 1 is a perspective view of an embodiment of the present invention in its normal vertical orientation.

FIG. 2 is a front plan view of the present invention, showing a close-up of the leveling device and housing and a cut-away view showing the contacting of the ruler by the tightening device.

FIG. 3 is a top plan view of the present invention, showing the second tightening device for securing the pointer to the housing.

### DETAILED DESCRIPTION OF THE INVENTION

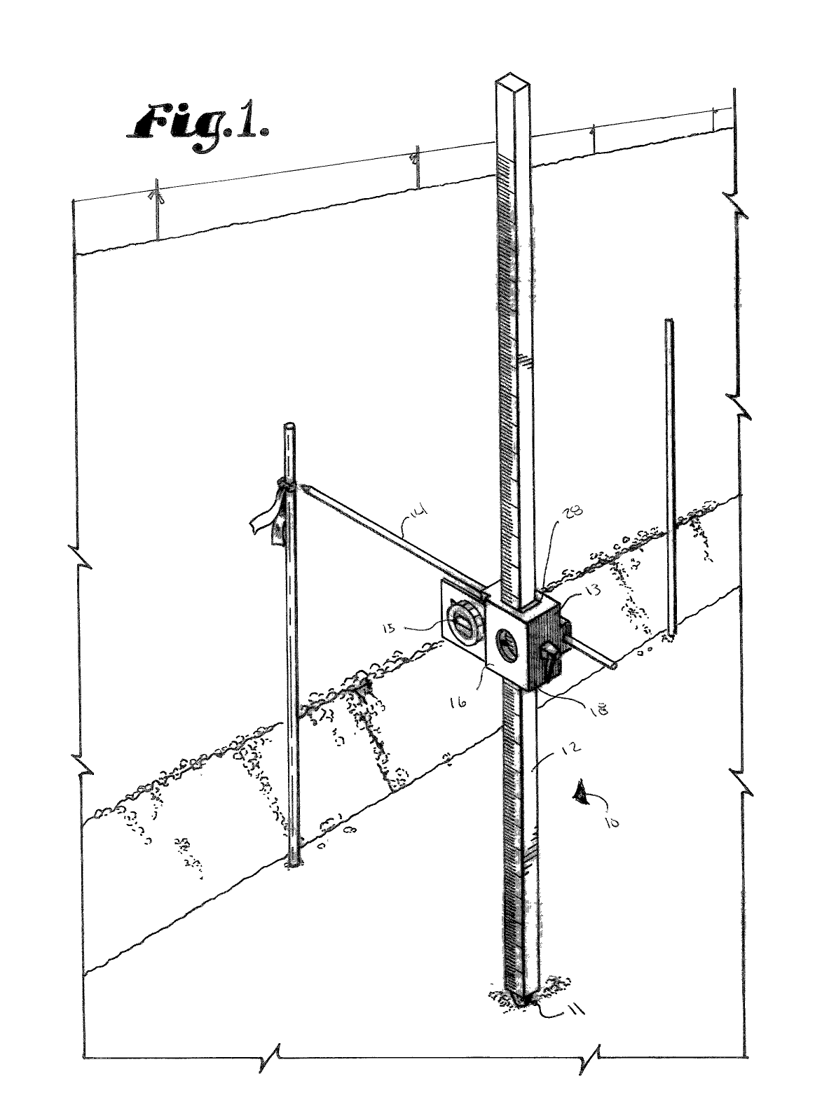

Referring now to the drawings, FIG. 1 shows an offset level 10 constructed in accordance with the present invention. The offset level includes a ruler 12 for measuring vertical height from the reference point, a housing 13 selectively slibable on the ruler for positioning the housing at a specific vertical height on the ruler, a pointer 14 extending outwardly from the housing for translating the desired vertical measurement to an offset location and having a measurement scale to permit the line to be measured from the reference point, and a leveling device 15 to insure that for horizontal alignment of the pointer during the offset location designation.

Ruler 12 includes a base 11 for contacting the reference point from which a vertical height and grade are determined and a generally rectangularly shaped rod with incremental markings on one face extending upwardly from base 11. The ruler 12 extends for a sufficient length to allow for various measurements of height for designating the location for a road construction.

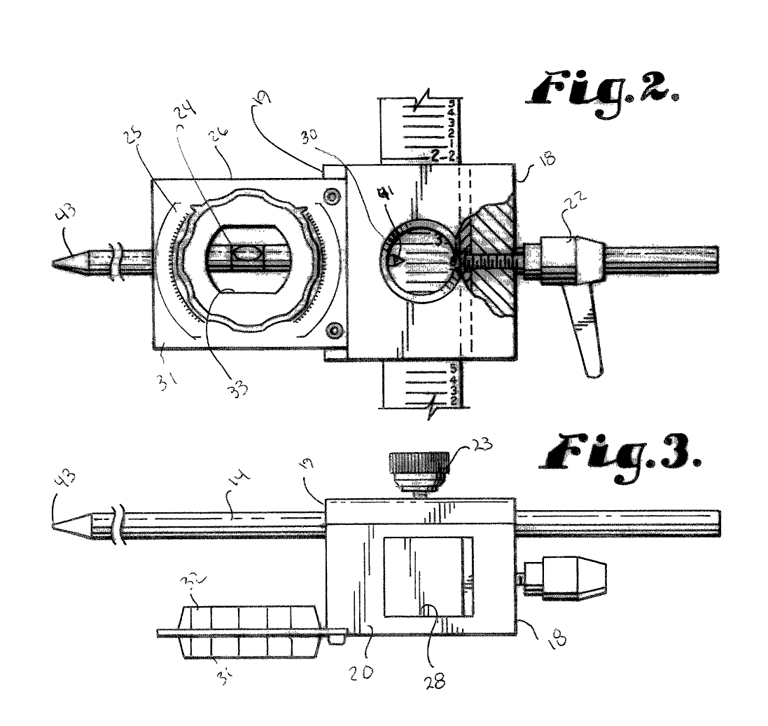

A housing 13 is slidably mounted to the ruler 12. Housing 13 has a front face 16, a back face 17, a medial face 18, a lateral face 19, a top face 20 and a bottom face 21, and is preferably made of metal. A vertical through-hole 28 extends from the top face 20 to the bottom face 21 and is generally rectangular in shape. The vertical through-hole 28 allows the housing to fit over, and travel longitudinally along, ruler 12. A front-face hole 30 in the housing 13 permits the viewing of the vertical dimension markings on the ruler 12 as the housing moves on the ruler 12. The front face hole 30 includes a marker 41 having a horizontal axis associated therewith to note a specific measurement reading on the vertical ruler. To fix the housing position at a desired point vertically along the ruler 12, a first tightening device 22 is attached to the lateral face 19 of the housing 13 and extends horizontally inward to the vertical through-hole 28 to contact ruler 12, as shown in FIG. 2. Preferably, the first tightening device 22 is a screw that can be rotated to come into and out of contact with the ruler 12 and is generally vertically centered on the housing 13. It is to be understood that other tightening devices may be used to fix the position of the housing onto ruler 12 without departing from the scope of the present invention.

The housing 13 further includes a cylindrically shaped horizontal through-hole 29 extending from medial face 18 to lateral face 19 and located rearward of the vertical through-hole 28 as shown in FIG. 1. For reasons that will become readily apparent, the horizontal through-hole 29 is positioned on housing 13 such that it has the same horizontal axis as the marker 41 of the housing. A pointer 14 is slidably received through horizontal through-hole 29 of housing 13. The pointer 14 is generally cylindrical in shape and is preferably a fiberglass round rod with an approximate length of three feet. The pointer 14 has a pointed medial end 43 for designating a measurement at a point horizontally offset from ruler 12.

To fix the line component for the guide wire marker, pointer 14 further includes measurement notations thereon that correspond to standard line measurements. The distal end 43 of pointer 14 can be fixed at a certain horizontal distance from vertical axis of vertical ruler through a second tightening device 23 attached to the back face 17 of the housing 13. The second tightening device 23 extends horizontally inward to the horizontal through-hole 29 to contact pointer 14, as shown in FIG. 3. Preferably, the second tightening device 23 is a screw that can be rotated to come into and out of contact with the pointer 14 and is vertically centered with the horizontal through-hole 29.

The present invention also comprises a leveling device 15 connected to the housing 13. The leveling device 15 ensures that the pointer 14 is in horizontal alignment such that the translated grade and line are accurate. The leveling device 15 is comprised of a liquid filled container 24, a circular dial 25, and a housing 26, and is centered vertically with respect to pointer 14. The housing 26 is a generally rectangular or square shaped metal plate with a circular hole 33 extending from the housing front face 31 to the housing back face 32. The housing 26 is attached to the medial side of the front face 16 of the housing 13. The front face 16 of the housing 13 is recessed inward on the medial side to allow for a flush interface with the housing front face 31. The housing front face 31 has a series of radial marks 27 spaced beyond the diameter of the circular dial 25 for measuring the angle of tilt of the pointer 14.

The circular dial 25 is a generally cylindrical object rotatably connected to the housing 26 through the circular hole 33 and extending beyond the housing front face 31 and housing back face 32. The dial 25 is oriented such that the longitudinal axis of the cylinder is horizontally aligned from front to back of the offset level 10. The outer circular surface of the dial 25 has a plurality of small depressions spaced along the circumference to aid in gripping the dial 25 for rotation. An angle marker 34 is also located on the circular dial 25 to allow for the designation of a desired angle of tilt. Such designation is accomplished by rotation of the dial 25 to align the angle marker 34 with the chosen increment of the radial marks 27 of the housing 13.

The present invention serves the dual purposes of designating a line and a grade or slope on a structure to which a guide wire will be placed for constructing a road or pathway surface. To operate the offset level 10, the base 11 of the ruler is placed on a previously surveyed reference position from which a line and grade position is measured. The housing 13 is slid vertically up or down the ruler until the desired height measurement on the ruler is viewed to be centered inside the front face hole 30, at which point the tightening device 22 is rotated to contact ruler 12 and hold the housing in position. Pointer 14 is extended for the predetermined distance from the reference point to establish the line. The second tightening device 23 is rotated clockwise to contact and hold pointer 14 in the appropriate position. The pointed end of pointer 14 thereby quickly and efficiently translates the line and grade of a particular reference point.

All of the above steps for using the offset level 10 can be performed by a single user without need of another person to adjust the device or designate the proper line and grade locations. Also, no special skills or training are needed to use the device other that knowing how to read a ruler for a height measurement and read radial marks to measure an angle of tilt. Further, it is to be understood that the invention described herein is equally applicable for designating a line or grade for any construction application where a level or sloped surface is desired.

The invention thus attains the objects set forth above and those apparent from the preceding description. Since certain changes may be made in the above systems and methods without departing from the scope of the invention, it is intended that all matter contained in the above description or shown in the accompanying drawing be interpreted as illustrative and not in a limiting sense.

The invention claimed is:

1. An apparatus for marking a line and grade for a guide wire from a reference point for use in road construction, the apparatus comprising,
a base having a bottom portion for contacting the reference point,
a ruler extending vertically upwardly from said base for measuring a vertical height component from said bottom portion,
a housing slidably mounted to the ruler, the housing being selectively fastenable to said ruler,
a pointer slidably received in the housing, the pointer being perpendicular with the ruler, and
a leveling device.

2. The apparatus of claim 1, wherein the leveling device is connected to the housing.

3. The apparatus of claim 1, wherein the housing comprises a top face, a bottom face, a front face, a back face, a medial face, and a lateral face, the housing having a vertically aligned through-hole extending from the top face to the bottom face to allow the housing to fit slidably on the ruler, and a horizontally aligned through-hole extending from the medial face to the lateral face to allow for the pointer to slidably fit on the housing.

4. The apparatus of claim 1 wherein the ruler comprises a generally rectangular shaped rod with incremental markings on one face for determining the height of the pointer

5. The apparatus of claim 1, wherein the pointer is a cylindrically shaped rod with a pointed end for marking a position.

6. The apparatus of claim 1 further comprising a first tightening device for securing the housing at a certain vertical position on the ruler.

7. The apparatus of claim 6 further comprising a second tightening device for securing the pointer such that a distal end of the pointer is at a certain horizontal distance from a vertical axis extending through the center of the ruler.

8. The apparatus of claim 7 wherein the first tightening device for securing the housing is a screw is mounted horizontally on the housing and contacting the ruler in a tightened position.

9. The apparatus of claim 8 wherein the second tightening device for securing the pointer is a screw is mounted horizontally on the housing and contacting the pointer in a tightened position.
